(19) United States
(12) Patent Application Publication
(10) Pub. No.: US 2024/0162723 A1
(43) Pub. Date: May 16, 2024

(54) Control circuit for operating a electrical energy store

(71) Applicant: Robert Bosch GmbH, Stuttgart (DE)

(72) Inventors: Philipp Zipf, Stuttgart (DE); Soenke Schuch, Leinfelden-Echterdingen (DE)

(21) Appl. No.: 18/079,583

(22) Filed: Dec. 12, 2022

(30) Foreign Application Priority Data
Nov. 10, 2022 (DE) 202022106322.2

(51) Int. Cl. H02J 7/00; H02J 7/34

(52) U.S. Cl. CPC H02J 7/0014; H02J 7/00308; H02J 7/345

(57) ABSTRACT

A control circuit for operating an electrical energy store has at least one electrical switching means, arranged in a current path for a charging or discharging current, for interrupting the charging or discharging current and with a suppressor diode, connected in parallel to the electrical switching means, for protecting the electrical switching means from an overvoltage when the electrical switching means is opened. An electrical attenuation element is connected in parallel to the suppressor diode in order to attenuate transients caused by a switching operation of the electrical switching means, in particular by an opening of the electrical switching means. The disclosure also relates to an electrical energy store and/or an electrical consumer with a control circuit according to the disclosure, and to a system consisting of an electrical consumer designed as a hand-held machine tool and at least one electrical energy store designed as an exchangeable battery pack.

This application claims priority under 35 U.S.C. § 119 to patent application no. DE 202022106322.2, filed on Nov. 10, 2022 in Germany, the disclosure of which is incorporated herein by reference in its entirety.

The disclosure relates to a control circuit for operating an electrical energy store and to an electrical consumer and an exchangeable battery pack with the control circuit according to the disclosure, and to a system consisting of an electrical consumer designed as a hand-held machine tool and at least one energy store designed as an exchangeable battery pack according to the disclosure.

### BACKGROUND

In order to protect an electrical energy store and/or an electrical consumer operable therewith, an electrical switching means is often provided in a current path in order to be able to interrupt the power supply in a critical load state. However, if the electrical switching means is opened under load, a high thermal and electrical load is usually generated. The prior art provides that this load is distributed among a plurality of electrical components. For example, a so-called TVS diode (transient voltage suppressor, hereinafter also referred to as a suppressor diode) can be connected in parallel to the switching means in order to protect the electrical switching means from overvoltage, in particular when the electrical switching means is opened. However, such a protective circuit does not offer full protection in any opening phase of the electrical switching means since the response time of the suppressor diode is limited by its design. In particular at the beginning of the opening process, the electrical switching means is therefore unprotected for a particular period of time and can be irreversibly damaged. In addition, if the suppressor diode is destroyed by the resulting overvoltage, a short circuit can result that leads to significant damage in the electrical energy store and/or in the electrical consumer.

An object of the disclosure is to achieve, in comparison to the prior art, improved protection of an electrical energy store and/or of an electrical consumer operable therewith, in particular in the event of a brief interruption of the power supply by a corresponding electrical switching means in the current path.

### SUMMARY

The disclosure relates to a control circuit for operating an electrical energy store with at least one switching means, arranged in a current path for a charging or discharging current, for interrupting the charging or discharging current and with a suppressor diode, connected in parallel to the switching means, for protecting the electrical switching means from overvoltage, in particular when the electrical switching means is opened. In order to achieve the above object, it is provided that an electrical attenuation element is connected in parallel to the suppressor diode in order to attenuate transients caused by a switching operation of the electrical switching means, in particular by an opening of the electrical switching means. Such an electrical attenuation element is often also referred to as a snubber. Quick transients can be discharged effectively and with little effort by the attenuation element or the snubber. In this way, protection is ensured during the entire switching operation, in particular during the entire switching-off operation, of the electrical switching means. Moreover, any destruction of the energy store and/or of the electrical consumer can be effectively prevented during such a switching operation.

Furthermore, the disclosure relates to an electrical consumer and/or an electrical energy store with the control circuit according to the disclosure, and to a system consisting of an electrical consumer designed as a hand-held machine tool and at least one electrical energy store designed as an exchangeable battery pack. However, all devices that can be powered by an electrical energy store, such as an exchangeable battery pack or a permanently integrated battery pack, and have an electrical load are basically to be understood as an electrical consumer in the context of the disclosure. The electrical load may be designed as a predominantly inductive load in the form of an electromotive drive. Likewise, predominantly ohmic or capacitive loads are conceivable. Electrically commutated electric motors (so-called EC or BLDC motors), the individual phases of which are controlled via at least one power transistor by pulse width modulation in order to control and/or regulate their speed and/or torque, are in particular suitable as electromotive drives. In this context, the disclosure can be applied to battery-powered machine tools for machining workpieces using an electrically driven insertion tool. The electrical consumer can be designed not only as a hand-held machine tool but also as a stationary machine tool. Typical machine tools in this context are hand-held or stationary drills, screwdrivers, impact drills, planers, angular grinders, oscillating sanders, polishing machines, or the like. However, suitable electrical consumers are also garden tools and construction equipment, such as lawn mowers, lawn trimmers, branch saws, tilling and trenching machines, blowers, robotic breakers and excavators, etc., as well as measuring devices, such as laser rangefinders, wall scanners, etc. Furthermore, the disclosure can be applied to household appliances, such as vacuum cleaners, mixers, etc., and to electrically powered road and rail vehicles, such as e-bikes, e-scooters, pedelecs, electric and hybrid vehicles, etc., as well as to airplanes and ships with control circuit according to the disclosure.

The voltage class of the energy stores results from the connection (in parallel or in series) of the individual energy store cells integrated in the energy stores and is usually an integer multiple (>=1) of the voltage of the individual energy store cells. An energy store cell is typically designed as a galvanic cell having a structure in which a cell pole comes to rest on one end and another cell pole comes to rest on an opposite end. In particular, the energy store cell has a positive cell pole at one end and a negative cell pole at an opposite end. Preferably, the energy store cells are designed as lithium-based battery cells, e.g., Li-ion, Li-cell polymer, Li-metal, or the like. However, the disclosure can also be applied to energy stores with Ni—Cd, Ni-Mh cells or other suitable cell types. In the case of conventional Li-ion energy store cells with a cell voltage of 3.6 V, voltage classes of 3.6 V, 7.2 V, 10.8 V, 14.4 V, 18 V, 36 V, etc. result, for example. Preferably, an energy store cell is designed as an at least substantially cylindrical round cell, wherein the cell poles are arranged at ends of the cylindrical shape. However, the disclosure does not depend on the type and design of the energy store cells used but can instead be applied to any energy stores and energy store cells, e.g., in addition to round cells, also to prismatic cells, pouch cells, or the like. The DC voltage values are primarily based on the typical cell voltages of the energy store cells used. For example, for pouch cells and/or cells with other electrochemical compositions, voltage values that differ from those of the energy stores equipped with Li-ion cells are possible.

If the energy store is designed as an exchangeable battery pack, it can be releasably connected in a non-positive or positive manner via an electromechanical interface of the exchangeable battery pack to a correspondingly complementary, electromechanical interface of the electrical consumer or of a charger. The term “releasable connection” is to be understood in particular as a connection that can be released and established without a tool, i.e., manually. The design of the electromechanical interfaces and their receptacles for the non-positively and/or positively releasable connection are not intended to be a subject matter of this disclosure. A person skilled in the art will select an appropriate embodiment for the electromechanical interface depending on the power or voltage class of an electrical consumer and/or of an exchangeable battery pack so that this is not discussed in further detail. The embodiments shown in the drawings are therefore only to be understood as examples. Interfaces with more than the illustrated electrical contacts may in particular also be used.

In a development of the disclosure, it is provided that the parallel circuit consisting of a suppressor diode and an electrical attenuation element or snubber is connected upstream of an electrical fuse. In a particularly advantageous manner, in the event of destruction of the suppressor diode, the remaining electronics of the energy store and/or of the electrical consumer can thereby also be protected from any damages.

The electrical attenuation element comprises at least one resistor and at least one capacitor (RC snubber) connected in series thereto. In addition, it may be provided that the electrical attenuation element comprises at least one diode connected in parallel to the at least one resistor (RDC snubber). Alternatively or additionally, the electrical attenuation element may furthermore comprise at least two capacitors (CC snubbers) connected in series and/or in parallel. Depending on the circuit variant, different protective effects can thus be achieved as a function of the effort.

Either a first reference potential, preferably a supply potential, or a second reference potential, preferably a ground potential, may be supplied to the current path, wherein the parallel circuit consisting of the suppressor diode and the electrical attenuation element is connected between the first reference potential and the second reference potential. This allows particularly simple connection with a high protective effect.

### BRIEF DESCRIPTION OF THE DRAWINGS

The disclosure is explained in the following with reference to FIGS. 1 to 5 by way of example, wherein identical reference signs in the figures indicate identical components with identical function.

The figures show:

FIG. 1: a schematic representation of a system consisting of at least one electrical energy store designed as an exchangeable battery pack and at least one electrical device, connectable to the exchangeable battery pack, for charging or discharging the exchangeable battery pack,

FIG. 2: a block diagram of the system according to FIG. 1 with an exchangeable battery pack and an electrical device designed as a charger with a control circuit according to the disclosure in a first exemplary embodiment,

FIG. 3: a block diagram of the system according to FIG. 1 with an exchangeable battery pack and an electrical device designed as a charger with a control circuit according to the disclosure in a second exemplary embodiment,

FIG. 4: a block diagram of the system according to FIG. 1 with an exchangeable battery pack with a control circuit according to the disclosure and an electrical device designed as an electrical consumer, in a third exemplary embodiment, and

FIGS. 5a and 5b: diagrams of the time curve of the relevant voltages and currents after the occurrence of a short circuit in the charger according to FIG. 2.

### DETAILED DESCRIPTION

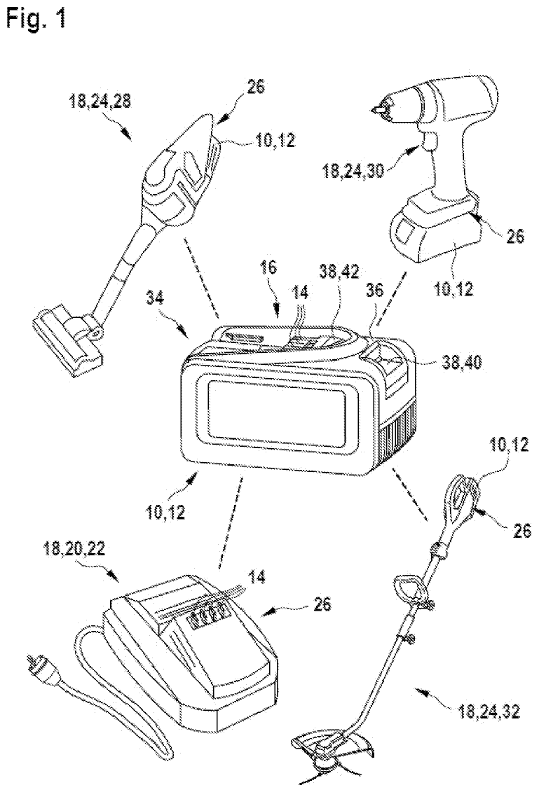

FIG. 1 shows a system comprising an electrical energy store 12 designed as an exchangeable battery pack 10 with a first electromechanical interface 16 comprising a plurality of electrical contacts 14 and with an electrical device 18, in particular a charger 20, a diagnostic device 22 or an electrical consumer 24, with a further electromechanical interface 26 comprising a plurality of electrical contacts 14. FIG. 1 is to illustrate that the system according to the disclosure is suitable for various electrical consumers 24 operated with exchangeable battery packs 10, without limiting the disclosure. By way of example, a battery vacuum cleaner 28, a battery impact wrench 30, and a battery lawn trimmer 32 are shown. However, in the context of the disclosure, a wide variety of power tools, garden tools, and household appliances may be suitable as electrical consumers 24. The number of exchangeable battery packs 10 may also vary within the system. The system may thus also comprise a plurality of exchangeable battery packs 10. It is moreover conceivable that the individual electrical consumers 24 are powered by means of a permanently integrated energy store 12 instead of an exchangeable battery pack 10. It should furthermore be noted that in FIG. 1, the charger 18 and the diagnostic device 20 are shown as one and the same electrical device 16 because a charger 18 may certainly also have a diagnostic function, but it is conceivable, without limiting the disclosure, that the diagnostic device 20 does not have a charging function but serves only to merely diagnose the exchangeable battery pack 10 for electrical error conditions.

The exchangeable battery pack 10 is substantially a conventional exchangeable battery pack for power tools with a housing 34, which, on a first side wall or its top side 36, comprises the first electromechanical interface 16 for releasable connection to the electromechanical interface 26 of the electrical device 18. In connection with the electrical consumer 24, the first and further electromechanical interfaces 16, 26 are primarily used to discharge the exchangeable battery pack 10, while, in connection with the charger 20, they are used to charge and in connection with the diagnostic device 22, to diagnose errors of the exchangeable battery pack 10. The exact design of the first and further electromechanical interfaces 16, 26 depends on various factors, such as the voltage class of the exchangeable battery pack 10 or of the electrical device 18 and various manufacturer specifications. For example, it is also possible to provide three or more electrical contacts 14 for energy and/or data transmission between the exchangeable battery pack 10 and the electrical device 18. Mechanical coding is also conceivable so that the exchangeable battery pack 10 can be operated only on specific electrical devices 18. Since the mechanical design of the first electromechanical interface 16 of the exchangeable battery pack 10 and of the further electromechanical interface 26 of the electrical device 18 is irrelevant to the disclosure, it is not to be discussed in further detail. Both a person skilled in the art and a user of the exchangeable battery pack 10 and of the electrical device 18 will make the appropriate selection in this respect.

The exchangeable battery pack 10 includes a mechanical locking device 38 for locking the positively and/or non-positively releasable connection of the first electromechanical interface 16 of the exchangeable battery pack 10 to the corresponding counter-interface 26 (not shown in detail) of the electrical consumer 24. The locking device 38 is designed as a spring-loaded push button 40 that is operatively connected to a locking element 42 of the exchangeable battery pack 10. Due to the spring of the push button 40 and/or of the locking element 42, the locking device 38 automatically engages into the electromechanical counter-interface 26 of the electrical consumer 24 upon insertion of the exchangeable battery pack 10. If a user presses the push button 40 in the insertion direction, the locking is released and the user can remove or extend the exchangeable battery pack 10 from the electrical consumer 24 in the direction opposite the insertion direction.

As already mentioned above, the battery voltage of the exchangeable battery pack 10 generally results from a multiple of the individual voltages of the energy store cells (not shown) as a function of their connection (in parallel or in series). Preferably, the energy store cells are formed as lithium-based battery cells, e.g., Li-ion, Li-po, Li-metal, or the like. However, the disclosure may also be applied to exchangeable battery packs with Ni—Cd, Ni-MH cells, or other suitable cell types.

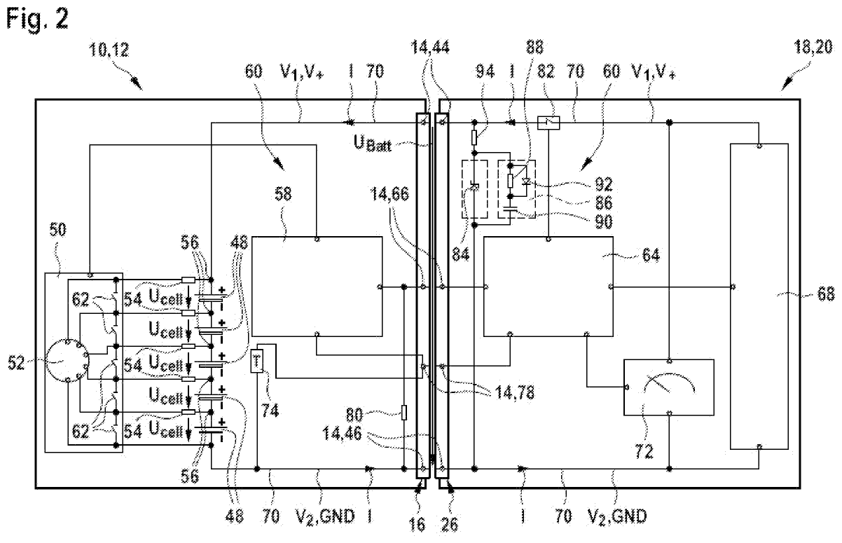

In FIG. 2, the system of FIG. 1 is shown as a block diagram with the energy store 12, designed as an exchangeable battery pack 10, on the left side and the electrical device 18, designed as a charger 20, on the right side. The exchangeable battery pack 10 and charger 18 comprise the mutually corresponding electromechanical interfaces 16 and 26 with a plurality of electrical contacts 14, wherein a respective first one of the electrical contacts 14 of the interfaces 16, 26 serves as an energy supply contact 44 which can be supplied with a first reference potential V₁, preferably a supply potential V₊, and a respective second one of the electrical contacts 14 of the battery interfaces 16, 26 serves as an energy supply contact 46 which can be supplied with a second reference potential V₂, preferably a ground potential GND. Via the first and second energy supply contacts 44, 46, the exchangeable battery pack 10 can on the one hand be charged by the charger 20. On the other hand, discharging of the exchangeable battery pack 10 also takes place via said supply contacts in the event that the electrical device 18 is designed as an electrical consumer 24. The phrase “can be supplied” is intended to clarify that the potentials V₊ and GND, in particular in the case of an electrical device 18 designed as an electrical consumer 24, are not permanently applied to the energy supply contacts 44, 46 but are only applied after connecting the electrical interfaces 16, 26. The same applies to a discharged exchangeable battery pack 10 after connection to the charger 20.

The exchangeable battery pack 10 comprises a plurality of energy store cells 48, which are shown in FIG. 2 as a series circuit but may alternatively or additionally also be operated in a parallel circuit, wherein the series circuit defines the voltage of the exchangeable battery pack U_{Batt} dropping across the energy supply contacts 44, 46, while a parallel circuit of individual energy store cells 48 primarily increases the capacity of the exchangeable battery pack 10. It is also possible to connect in series individual cell clusters consisting of energy store cells 48 connected in parallel, in order to achieve a specific voltage of the exchangeable battery pack 10 U_{Batt} with simultaneously increased capacity. For conventional Li-ion energy store cells 48 with a cell voltage U_{Cell} of 3.6 V each, a battery voltage U_{Batt}=V₁−V₂ of 5·3,6 V=18 V drops across the energy supply contacts 44, 46 in the present exemplary embodiment. Depending on the number of energy store cells 48 connected in parallel in a cell cluster, the capacity of conventional exchangeable battery packs 10 can be up to 12 Ah or more. However, the disclosure is not dependent on the type, design, voltage, power supply capability, etc. of the energy store cells 48 used but can be applied to any energy stores 12 and energy store cells 48.

For monitoring the individual energy store cells 48 connected in series, or the cell clusters of the exchangeable battery pack 10, a single-cell monitoring (SCM) pre-stage 50 is provided. The SCM pre-stage 50 comprises a multiplexer measuring device 52 which, via filter resistors 54, can be connected with high impedance to corresponding taps 56 of the poles of the energy store cells 48 or cell clusters. In order to sense the individual cell voltages, U_{Cell}, the multiplexer measuring device 52 sequentially switches, for example via integrated transistors not shown in more detail, between the individual taps 56 in such a way that it is always connected to a positive and a negative pole of the energy store cell 48 to be measured or the cell cluster to be measured. In the following, the term “energy store cell” is also to include the cell cluster since they only affect the capacity of the exchangeable battery pack 10 but are equivalent with regard to the detection of the cell voltages U_{Cell}. The filter resistors 54, which are in particular designed with high impedance, can in particular prevent a dangerous heating of the measurement inputs of the multiplexer measuring device 52 in the event of a fault.

The switching of the multiplexer measuring device 52 takes place via a first monitoring unit 58, which is integrated in the exchangeable battery pack 10 and is part of a control circuit 60. The first monitoring unit 58 may also close or open switching elements 62, connected in parallel to the energy store cells 48, of the SCM pre-stage 50 in order to, in this way, cause a so-called balancing of the energy store cells 48 to achieve uniform charge and/or discharge states of the individual energy store cells 48. It is likewise conceivable that the SCM pre-stage 50 passes the measured cell voltages U_{Cell} directly to the first monitoring unit 58 so that the actual measurement of the cell voltages U_{Cell} is performed directly by the first monitoring unit 58, for example via a corresponding analog-digital converter (ADC).

The first monitoring unit 58 may be designed as an integrated circuit in the form of a microprocessor, ASIC, DSP, or the like. It is likewise conceivable that the first monitoring unit 58 consists of a plurality of microprocessors or at least in part of discrete components with corresponding transistor logic. In addition, the first monitoring unit 58 may comprise a memory for storing operating parameters of the exchangeable battery pack 10, such as the voltage U_{Batt}, the cell voltages U_{Cell}, a temperature T, a charging or discharging current I, or the like.

In addition to the first monitoring unit 58 in the exchangeable battery pack 10, the electrical device 18 of the system also comprises a further monitoring unit 64 of a corresponding control circuit 60, which may be designed analogously to the first monitoring unit 58. The first and the further monitoring units 58 and 64, respectively, may, preferably digitally, exchange information via a third contact 14, designed as a signal or data contact 66, of the two electromechanical interfaces 16, 26.

The further monitoring unit 64 of the electrical device 18 designed as the charger 20 controls a power output stage 68 which is connected to the first and second energy supply contacts 44, 46 of the further interface 26 and via which the exchangeable battery pack 10 plugged into the charger 20 can be charged with the charging current I flowing over the corresponding current paths 70 and with the voltage U_{Batt} corresponding to the exchangeable battery pack 10. For this purpose, the charger 20, or the power output stage 68, is provided with a mains connection not shown. The voltage U_{Batt} applied to the energy supply contacts 44, 46 may be measured via a voltage measuring device 72 in the charger 20 and evaluated by the further monitoring unit 64. The voltage measuring device 72 may also be fully or partially integrated into the monitoring unit 62, for example in the form of an integrated ADC.

By means of a temperature sensor 74 which is arranged in the exchangeable battery pack 10, is preferably designed as an NTC, and is in close thermal contact with at least one of the energy store cells 48, a temperature T of the exchangeable battery pack 10 or of the energy store cells 48 can be measured and evaluated by the further monitoring unit 64 of the charger 20. To this end, the temperature sensor 74 is on the one hand connected to the second reference potential V₂, in particular to the ground potential GND, applied to the second energy supply contact 46, and on the other hand to a contact 14, designed as a signal or data contact 78, of the first interface 16 of the exchangeable battery pack 10. Accordingly, a signal or data contact 78 is provided in the further interface 26 of the charger 20 and is connected to the further monitoring unit 64. Furthermore, there is a connection between the signal or data contact 78 of the first interface 16 of the exchangeable battery pack 10 and the first monitoring unit 58 of the exchangeable battery pack 10. Via this connection, the first monitoring unit 58 can determine whether the temperature T measured by the temperature sensor 74 has been interrogated by the further monitoring unit 64 of the charger 20. If so, the first monitoring unit 58 is automatically transitioned from a sleep mode into an operating mode. If no such interrogation takes place, the sleep mode of the first monitoring unit 58 allows significantly longer idle and storage periods of the exchangeable battery pack 10 due to the reduced quiescent current.

In order for the charger 20 to identify and, if necessary, release the exchangeable battery pack 10 for charging, the exchangeable battery pack 10 has a coding resistor 80, which is connected on one side to the second reference potential V₂, in particular to the ground potential GND, applied to the second energy supply contact 46, and on the other side to the third contact 14, designed as a signal or data contact 66, of the first interface 16 of the exchangeable battery pack 10. If the resistance value of the coding resistor 80 matches a value stored in the further monitoring unit 64 of the charger 20, the charger 20 releases the charging process and charges the exchangeable battery pack 10 according to the charging parameters stored in a look-up table, in particular the charging current I, the charging voltage U_{Batt}, the permitted temperature range, etc.

In the current path 70, supplied with the first reference potential V₁ or the supply potential V₊, for the charging current I, the control circuit 60 of the charger 20 comprises at least one electrical switching means 82 for interrupting the charging current I or the power supply, in particular in a critical load state. For example, if a short circuit arises in the electronics of the charger 20 and/or of the exchangeable battery pack 10 during operation, this leads to immediate emergency shutdown by the further monitoring unit 64 of the charger 20 opening the electrical switching means 82. However, if the electrical switching means 82 is opened under load, a high thermal and electrical load usually arises, as a result of a sharply increasing charging current I, at least until detection of the fault and can lead to destruction of the electrical components of the exchangeable battery pack 10 and/or of the charger 20. The current increase rate is in this case only limited by the internal resistance and the inductance of the current paths 70. The electrical switching means 82 may, for example, be implemented as a MOSFET, a bipolar transistor, an IGBT, a relay, or the like.

By means of a TVS or suppressor diode 84, the electrical switching means 82 can be protected, in particular during its opening process, in such a way that the suppressor diode 84 discharges any resulting overvoltage to the second reference potential V₂ or the ground potential GND. For this purpose, the cathode of the suppressor diode 84 is supplied with the first reference potential V₁ or the supply potential V₊, and the anode is supplied with the second reference potential V₂ or the ground potential GND. However, such a protective circuit does not provide full protection in every opening phase of the electrical switching means 82 since the response time of the suppressor diode 84 is limited by its design. In particular at the beginning of the opening process, the electrical switching means 82 is therefore unprotected for a particular period of time and can be irreversibly damaged. In addition, if the suppressor diode 84 is destroyed by the resulting overvoltage, a short circuit can result that leads to significant damage in the exchangeable battery pack 10 and/or in the charger 20. In order to attenuate transients caused by the switching operation, an electrical attenuation element 86 is connected in parallel to the suppressor diode 84. The electrical attenuation element 86 comprises a resistor 88 and a capacitor 90 connected in series thereto. Furthermore, a diode 92 is connected in parallel to resistor 88 in such a way that its anode is supplied with the first reference potential V₁ or the supply potential V₊. Due to its used components, such an electrical attenuation element 86 is also referred to as an RDC snubber, which provides effective protection during the entire switching operation, in particular during the entire switching-off operation, of the electrical switching means 82, whereby any destruction of the exchangeable battery pack 10 and/or of the charger 20 can also be effectively prevented.

The parallel circuit formed from the suppressor diode 84 and the electrical attenuation element or the snubber 86, is also connected upstream of an electrical fuse 94 in order to protect both the suppressor diode 84 and the electrical attenuation element 86 from possible destruction. It is likewise possible for the electrical fuse 94 to only be connected upstream of the suppressor diode 84 itself in order to protect it from destruction.

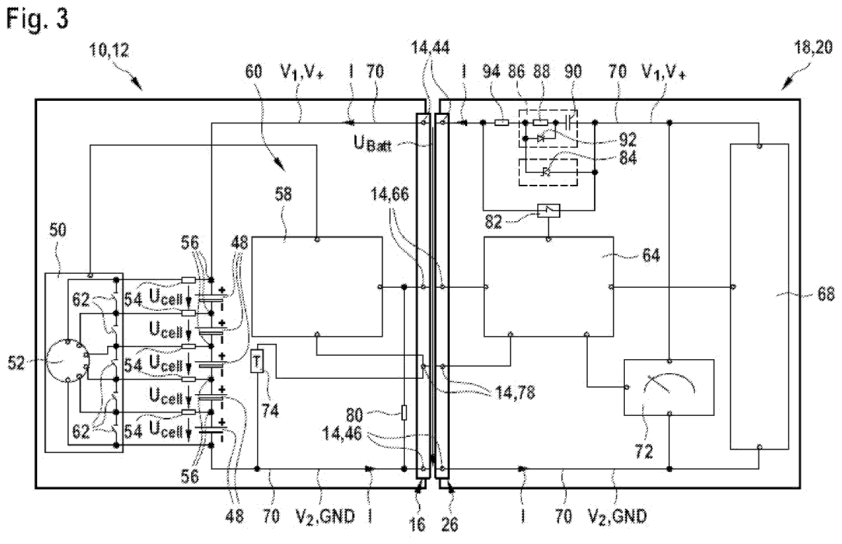

FIG. 3 shows another embodiment of the control circuit 60 according to the disclosure for the charger 20. Since all components and assemblies of the exchangeable battery pack 10 and of the charger 20 are identical except for the arrangement of the suppressor diode 84, the electrical attenuation element 86, the electrical fuse 94 and the electrical switching means 82, the components and assemblies are not to be discussed in detail again below. In contrast to the first exemplary embodiment according to FIG. 2, the suppressor diode 84, including the attenuation element 86 connected in parallel and the fuse 94 connected upstream, is now directly connected in parallel to the electrical switching means 82 in the current path 70 supplied with the first reference potential V₁ or supply potential V₊.

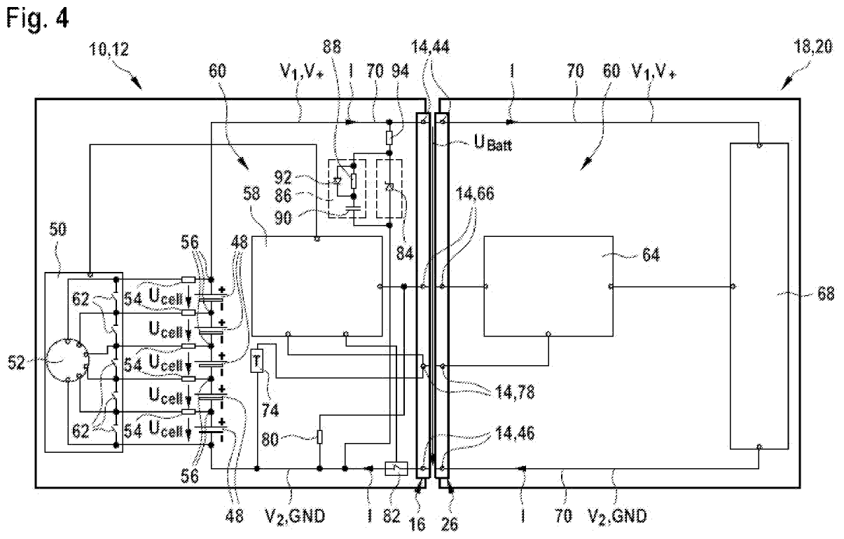

In contrast to FIGS. 2 and 3, the electrical device 18 in FIG. 4 is no longer designed as a charger 20 but as an electrical consumer 24, e.g., as a power tool, a garden tool, or the like according to FIG. 1. Analogously to the charger 20, the control circuit 60 of the electrical consumer 24 comprises the further monitoring unit 64, which inter alia, preferably digitally, captures, via the third contact 14, designed as a signal or data contact 66, of the two electromechanical interfaces 16, 26, information about the coding resistor 80 of the exchangeable battery pack 10. To this end, the further monitoring unit 64 compares the sensed resistance value of the coding resistor 80 with a value stored in its memory. If the values do not match, the discharging process of the exchangeable battery pack 10 is discontinued or not allowed so that the electrical consumer 24 cannot be put into operation. If they match, a user can put the electrical consumer 24 into operation. With particular advantage, this allows for operation of exchangeable battery packs 10 of different power classes with the same electromechanical interfaces 16 and 26. It is of course understood that in the case of an electrical consumer 24, the power output stage 68, included in the charger 20, according to FIGS. 2 and 3 is designed as a drive unit, e.g., as an electric motor (if necessary, with a power output stage correspondingly connected upstream) or another power-consuming unit. The design of such a unit is not to be discussed further here since it is well known to the person skilled in the art for various types of electrical consumers 24 and moreover is not of vital importance to the disclosure as such. Instead of the one coding resistor 80, a further coding resistor may additionally also be used in the exchangeable battery pack 10 in order to be able to distinguish between the charging process in connection with the charger 20 and the discharging process in connection with the electrical consumer 24.

Another difference between the exemplary embodiments according to FIGS. 2 and 3 and the exemplary embodiment according to FIG. 4 is that the suppressor diode 84, the electrical attenuation element 86 designed as an RDC snubber, the electrical fuse 94 and the electrical switching means 82 are components of the control circuit 60 of the exchangeable battery pack 10, wherein the circuit arrangement according to FIG. 2 formed from the suppressor diode 84, the RDC snubber 86 and the electrical fuse 94 is connected between the first energy supply contact 44, supplied with the supply potential V₊, and the second energy supply contact 46, supplied with the ground potential GND, of the electromechanical interface 16. In addition, for interrupting the discharging current I or the power supply, in particular in a critical load state, the electrical switching means 82 is connected in the current path 70 supplied with the ground potential GND, wherein the control of the electrical switching means 82 takes place via the first monitoring unit 58 of the exchangeable battery pack 10. However, additionally or alternatively, the electrical switching means 82 may also be controlled by means of the further monitoring unit 64 of the electrical consumer 24 via the third and/or fourth contact 14, designed as a signal or data contact 66, 78, of the two electromechanical interfaces 16, 26. Naturally, with reference to FIG. 3, it is also conceivable that the circuit arrangement formed from the suppressor diode 84, the electrical attenuation element 86 and the electrical fuse 94, is connected directly in parallel to the electrical switching means 82.

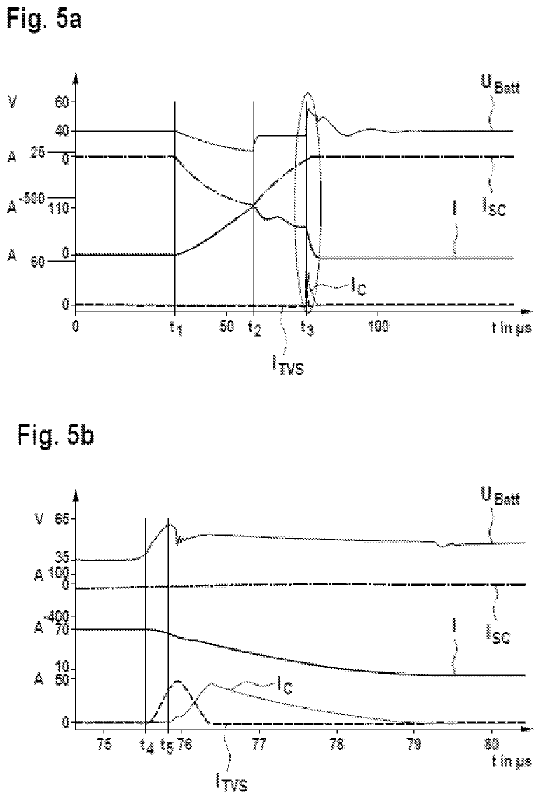

FIG. 5 shows a diagram of the curve of the battery voltage U_{Batt}, of the short-circuit current I_{SC}, of the charging current I, of the current I_{C} through the capacitor 102 of the electrical attenuation element 86 and of the current I_{TVS} through the suppressor diode 84 after the occurrence of a short circuit in the power output stage 68 of the charger 20 according to the exemplary embodiment of FIG. 2 as a function of the time t in μs. FIG. 5b shows a detail of FIG. 5a.

The nominal battery voltage U_{Batt} of the exchangeable battery pack 10 is 36 V. At time t₁, according to FIG. 5a, an unforeseen short circuit occurs in the power output stage 68 of the charger 20, whereupon the battery voltage U_{Batt} drops to approx. 25 V after approx. 25 μs until the further monitoring unit 64 of the control circuit 60 of the charger 20 switches off the corresponding power transistor in the power output stage 68 at time t₂. Accordingly, the short-circuit current I_{SC} in the power output stage 68 and the charging current I of the exchangeable battery pack 10 increase within this time window. At time t₂, the currents I and I_{SC} drop again while the battery voltage U_{Batt} jumps to its nominal value. At time t₃, the electrical switching means 82 is then opened or switched off by the further monitoring unit 64 in order to interrupt the charging current I or the energy supply. Although the short-circuit current I_{SC} has almost reached the value of zero again by then, a transient in the form of an overvoltage of the battery voltage U_{Batt} arises as a result of switching off the electrical switching means 82 and must be discharged as quickly as possible. This task is fulfilled by the attenuation element 86 according to the disclosure according to FIG. 5b in that the resulting current I_{TVS} can be conducted through the suppressor diode 84 from time t₄. In doing so, the energy is stored in the capacitor 90 of the electrical attenuation element 86 until the suppressor diode 84 has become significantly conductive at time t₅. Subsequently, the stored energy may be dissipatively converted to heat via the resistor 88 of the electrical attenuation element 86.

It should lastly be pointed out that the exemplary embodiment shown is limited neither to FIGS. 1 to 5 nor to the stated or shown values of the voltages and currents. In addition, the corresponding basic circuits can consist of individual components (e.g., capacitors, diodes, resistors, etc.), of a parallel or series circuit, or an anti-series circuit of the electrical components, or any combination of these circuit variants.

1. A control circuit configured to operate an electrical energy store, comprising:
at least one electrical switching device, arranged in a current path configured to charge or discharge current, configured to interrupt the charging or discharging current;
a suppressor diode, connected in parallel to the electrical switching device, configured to protect the electrical switching device from an overvoltage when the electrical switching device is opened; and
an electrical attenuation element connected in parallel to the suppressor diode and configured to attenuate transients caused by the opening of the electrical switching device.

2. The control circuit according to claim 1, further comprising:
an electrical fuse connected upstream of the parallel circuit consisting of the suppressor diode and the electrical attenuation element.

3. The control circuit according to claim 1, wherein the electrical attenuation element comprises at least one resistor and at least one capacitor connected in series with the at least one resistor.

4. The control circuit according to claim 3, wherein the electrical attenuation element comprises at least one diode connected in parallel to the at least one resistor.

5. The control circuit according to claim 1, wherein the electrical attenuation element comprises at least two capacitors connected in series and/or in parallel.

6. The control circuit according to claim 1, wherein:
the current path is supplied either with a supply potential, or with a ground potential; and
the parallel circuit consisting of the suppressor diode and the electrical attenuation element is connected between the supply potential and the ground potential.

7. An electrical energy store in the form of an exchangeable battery pack, with a control circuit according to claim 1.

8. A system comprising:
an electrical consumer with a control circuit according to claim 1.

9. The system according to claim 8, wherein the electrical consumer is configured as a hand-held machine tool, the system further comprising:
the electrical energy store according to claim 7 designed as an exchangeable battery pack.
